(19) United States
(12) Patent Application Publication
(10) Pub. No.: US 2008/0307356 A1
(43) Pub. Date: Dec. 11, 2008

(54) Navigation apparatus and navigation program

(75) Inventor: Hiroshi Kawauchi, Okazaki-shi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD., Anjo-shi (JP)

(21) Appl. No.: 12/153,672

(22) Filed: May 22, 2008

(30) Foreign Application Priority Data
Jun. 8, 2007 (JP) 2007-152487
Mar. 28, 2008 (JP) 2008-086456

(51) Int. Cl. G06F 3/048

(52) U.S. Cl. 715/810

(57) ABSTRACT

Recognizing that a search target must be particular identifying words, words that are shared by a plurality of sets of destination data are stored as search keywords appended to individual sets of destination data that serve as the search targets. In execution of a search for a destination, keywords that in part match the input characters are displayed as selectable keys. It is possible to reduce user input operations by creating a menu of relevant keywords. Reduction in the number of user operations becomes possible by selecting keywords having three or more characters by a total of two operations, that is, the input of at least one character to retrieve a narrowed down group of keywords and selection of one of the retrieved keywords.

### INCORPORATION BY REFERENCE

The disclosures of Japanese Patent Application No. 2007-152487 filed on Jun. 8, 2007, and Japanese Patent Application No. 2008-086456 filed on Mar. 28, 2008 including the specification, drawings and abstract are incorporated herein by reference in their entirety.

### BACKGROUND OF THE INVENTION

1. Field of the Invention

The present invention relates to navigation apparatus and navigation programs and, more specifically, to navigation apparatus and navigation programs that search for a site based on input of a character string.

2. Description of the Related Art

In recent years, the use of navigation apparatuses to guide vehicle travel has become widely adopted. A navigation apparatus functions to search for routes from a departure point to a destination, to detect the location of the vehicle by using GPS (Global Positioning System) satellites and sensors such as gyroscopes, and to display the route to the destination and the current location of a driver's vehicle on a map. Generally, in a navigation apparatus, as shown in Japanese Patent Application Publication No. JP-A-H11-271084, when searching for, for example, the name of place or name of facility of a destination, candidate locations are narrowed down by inputting a name, an address, a telephone number, or the like through a touch panel. Then, when the input and a search based on a genre have been completed, a narrowed down list of candidate locations is displayed on a display screen, and the user selects a desired destination from among the listed candidate locations.

### SUMMARY OF THE INVENTION

However, when a search is made for a location of a destination by input of a name, it is necessary to input one character at a time which is inconvenient in terms of the number of operations and operation time. In addition, it is not possible to carry out the search based on characters that are not included.

Mobile telephones which display a list of candidates complementing input characters are known, but such phones only display matches with beginning characters and characters that have been previously input, and cannot narrow down the number of candidates based on those portions of input character strings other than the beginning characters. In addition, in a mobile telephone, because of adaption to general use assuming the input of all types of characters, frequently unnecessary words are displayed as candidates, thus making use more difficult.

In contrast, in a navigation apparatus, in the case in which the candidate locations for a destination that have been narrowed down by a search are displayed in a list, they are displayed either in alphabetical order or in the order of coordinates (for example, from north to south). However, when the order of listed candidates is displayed in this manner and there are numerous candidate locations, frequently many candidate locations other than those with higher priority are displayed, thus making use more difficult.

Thus, it is an object of the present invention to provide a more efficient input operation for a destination search in a navigation apparatus.

According to the present invention, keywords that include the input characters are narrowed down and displayed, and the destination data that includes the selected keywords is narrowed down to candidate destinations, and thus it is possible to efficiently execute input for a destination search.

### BRIEF DESCRIPTION OF THE DRAWINGS

FIG. 1 is a block diagram of an embodiment of a navigation apparatus in accordance with the present invention;

FIG. 2 is a table of the contents of destination data (location information) that is stored in a destination data file;

FIG. 3 is a table of keywords as contained and arranged in a keyword data file;

FIG. 4 is a listing of priority score modifying rules;

FIG. 5 is a schematic diagram of an input device and display;

FIG. 6 is a flowchart of a destination setting routine in accordance with the present invention;

FIGS. 7A and 7B illustrate destination setting screens;

FIGS. 8A to 8D illustrate differences in the display of a listing of location candidates in the case in which the order of priority is changed according to a seasonal rule as the priority order score modifying rule;

FIG. 9A to 9D illustrate differences in the display of a listing of location candidates in the case in which the order of priority is changed according to a weather rule applied as the priority order score modifying rule;

FIGS. 10A to 10C illustrate differences in the display of a listing of location candidates in the case in which the order of priority is changed according to a time rule applied as the priority order score modifying rule;

FIGS. 11A to 11C illustrate differences in the display of a listing of location candidates in the case in which the order of priority is changed according to a calendar rule applied as the priority order score modifying rule;

FIGS. 12A to 12C illustrate differences in the display of a listing of location candidates in the case in which the order of priority is changed according to a present location rule applied as the priority order score modifying rule;

FIGS. 13A to 13C illustrate differences in the display of a listing of location candidates in the case in which the order of priority is changed according to a destination rule applied as the priority order score modifying rule;

FIGS. 14A and 14B illustrate differences in the display of a listing of location candidates in the case in which the order of priority is changed according to a location rule applied as the priority order score modifying rule;

FIGS. 15A and 15B illustrate differences in the display of a listing of location candidates in the case in which the order of priority is changed according to a genre rule applied as the priority order score modifying rule;

FIG. 16 is a schematic representation of the content of the destination data (location information) that is stored in the destination data file in a navigation apparatus with US specifications in accordance with the present invention;

FIG. 17 is a schematic representation of the keywords contained in the keyword data file in the navigation apparatus with US specifications;

FIG. 18 is a schematic diagram of the input apparatus and the display in the navigation apparatus that has US specifications;

FIGS. 19A and 19B are schematic diagrams of destination setting screens in the navigation apparatus with US specifications;

FIGS. 20A to 20D illustrate differences in the display of a listing of location candidates in the case in which the order of priority is changed according to the season rule applied as the priority order score modifying rule in the navigation apparatus with US specifications;

FIGS. 21A to 21D illustrate differences in the display of a listing of location candidates in the case in which the order of priority is changed according to a weather rule applied as the priority order score modifying rule in the navigation apparatus with US specifications;

FIGS. 22A to 22D illustrate differences in the display of a listing of location candidates in the case in which the order of priority is changed according to a time rule applied as the priority order score modifying rule in the navigation apparatus with US specifications;

FIGS. 23A to 23C illustrate differences in the display of a listing of location candidates in the case in which the order of priority is changed according to a calendar rule applied as the priority order score modifying rule in the navigation apparatus with US specifications;

FIGS. 24A to 24C illustrate differences in the display of a listing of location candidates in the case in which the order of priority is changed according to a current location rule applied as the priority order score modifying rule in the navigation apparatus with US specifications;

FIGS. 25A to 25C are explanatory drawings that represent the differences in the display of the lists in the case in which the order of priority is changed according to a destination rule applied as the priority order score modifying rule in the navigation apparatus that has US specifications;

FIGS. 26A and 26B illustrate differences in the display of a listing of location candidates in the case in which the order of priority is changed according to a location rule applied as the priority order score modifying rule in the navigation apparatus with US specifications; and

FIGS. 27A and 27B illustrate differences in the display of a listing of location candidates in the case in which the order of priority is changed according to a genre rule applied as the priority order score modifying rule.

### DESCRIPTION OF THE PREFERRED EMBODIMENTS

Based on a recognition that a navigation apparatus search is limited to particular words (names of locations and the like), in the present invention identical words that are contained in a plurality of sets of destination data are extracted as search keywords, and saved in a keyword data file. In other words, search keywords are created by extracting identical words that are contained in plural sets of destination data, and these search keywords are saved as keyword data. For example, words that are used as a plurality of location names (destination locations) and various identical words such as “supermarket”, “university”, “information”, “center”, land”, bank”, “amusement park”, “golf” and the like are extracted as keywords. Search keywords for name, address, and genre are appended to individual sets of destination data, which serve as search targets.

When searching for a destination, keywords that partially match the input characters are retrieved, and the thus retrieved keywords are displayed as selectable keys. Thus, it is possible to omit input operations which would otherwise be required for selecting a corresponding keyword. For example, the number of required operations is reduced by selecting a keyword having three or more characters in a total of two operations: inputting at least one character and the selection of a keyword. In the present embodiment, a partial matching is used, but a search for matching of the beginning character is also possible.

After the keywords have been narrowed down by using character input and the keywords which the input characters partially match are displayed as a list (menu) and a keyword is selected from the displayed list, then, destinations having destination data to which matching keywords are appended, are selected (set) as candidate destinations and displayed in a second list (menu). Thus, the narrowing down is based on a partial matching with given characters in a reading of stored keywords included in the destination data. For example, for a restaurant named “Missoni Miso Cooking”, due to the input of the characters “co”, the keyword “cooking” becomes one of the candidate destinations to be narrowed down because the restaurant name includes the keyword “cooking”. Thus, a search can be carried out using only part of the memory.

For each keyword that is stored in the keyword data file, an additional keyword or keywords associated with this keyword is/are stored as associated keywords. Thereby, it is also possible to carry out a search for candidates based on words that are not included in the destination (name, address, genre) that is a search target.

In this manner, by using not only a character unit as the input unit, but also keywords that have been inferred (narrowed down) based on the input characters and the associated keywords, the number of the input operations can be reduced, a search for a wider range of locations becomes possible, and the inputting is thereby simplified. In addition, by creating a navigation keyword dictionary that is based on location information, excesses and deficiencies in location searches are eliminated, and the inputting and searching become more suitable for navigation.

Furthermore, a priority level (value) for determining the listing priority order is appended to each of the keywords. The priority level is set, for example, higher as the number of times that it is used in setting the destinations becomes larger, or is determined in advance based on statistical values that represent actual use. When an acceptance key is operated by the user after the character input for narrowing down and keyword selection, the candidate destinations (locations) are displayed in a list in a sequence starting with the destination candidate having the highest priority level, after updating the priority levels of the candidate destinations according to priority order score modifying rules that modify the priority level depending on, for example, the season and the location. Thereby, the narrowed-down candidate destinations can be displayed in a list in an order that is in accord with the preferences of the user.

### First Embodiment

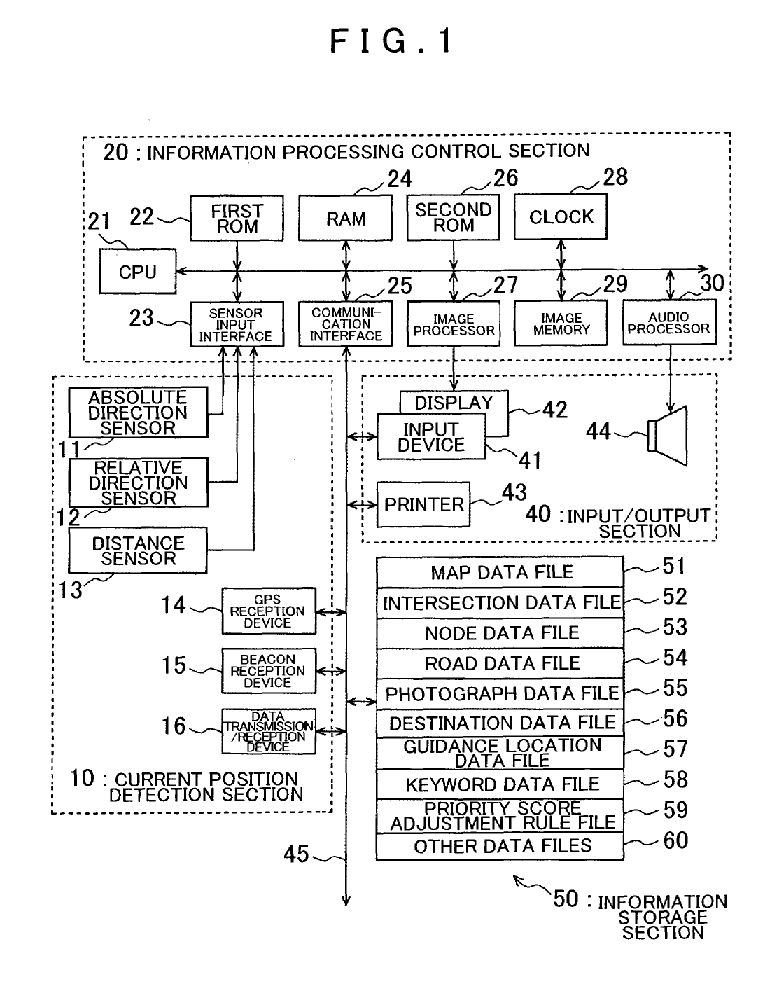

FIG. 1 is a block diagram of a first embodiment of a navigation apparatus in accordance with the present invention. As shown in FIG. 1, this navigation apparatus is mounted on a vehicle, and is provided with a current location detecting section 10, an information processing and controlling section 20, an input-output section 40, and an information storing section 50. The current location detecting section 10 includes an absolute direction sensor 11 which may be a geomagnetism sensor that detects the direction in which the vehicle is oriented based on magnetic detection of North or may be a unit that detects the absolute direction.

The relative direction sensor 12 is a sensor that detects, for example, whether or not the vehicle has turned at an intersection, and may be an optical rotation sensor or a potentiometer-type sensor that is attached to a component which rotates with the steering wheel, or an angle sensor that is installed adjacent a steerable vehicle wheel. Alternatively, a gyroscopic sensor that determines changes in the steering angle by detecting angular velocity may be used. Any unit that can detect an angle that changes relative to a reference angle (absolute direction) may be used. The distance sensor 13 may be a unit that, for example, detects and counts the rotations of the wheels, a unit that detects acceleration and integrates the results twice, or any device that can measure the distance the vehicle has traveled.

The GPS (Global Positioning System) receiving device 14 is a device that receives signals from satellites, and thereby obtains a variety of information, such as the time that a signal has been transmitted, information as to the location of the receiving device, the traveling speed of the receiving device, the traveling direction of the receiving device and the like. The beacon receiver 15 is a device that receives signals transmitted from stationary transmitters installed at specified locations. Also, the apparatus can acquire VICS information, including information that is related to the travel of the vehicle, such as traffic congestion information, current location information, and parking area information.

The data transmitting and receiving device 16 communicates with facilities remote from the vehicle by telephone circuits and/or radio for exchange of information. The data transmitting and receiving device 16 may be a vehicle telephone, ATIS, or VICS, and may provide GPS correction, communication between vehicles and the like, and in general, input and output of information related to travel. The information processing and controlling section 20 is a unit for computing and control based on information input from the current location detecting section 10 and the input-output section 40, and information that is contained in the information storing section 50, and controls output of the results of the computations to units such as a display 42, a printer 43, and/or a speaker 44.

The information processing and controlling section 20 includes a central processing unit (CPU) 21 which provides computing and control for the entire navigation apparatus. The first ROM 22 contains navigation programs related to, in particular, the detection of the current location, search for routes, display of guidance, and the like. The input interface 23 receives information from the current location detecting section 10.

The RAM 24 is a unit for storing information that has been input by a user, such as information on the destinations, transit points, and the like, and for storing the results of computations by the CPU 21 based on information that has been input by the user, the results of route searches, and map information that has been read from the information storing section 50. The communication interface 25 is a unit for inputting and outputting information from the current location detecting section 10, and in particular, information that is obtained from external (remote) sources.

The second ROM 26 contains programs that are related to navigation, and in particular, navigation programs related to audio guidance. The image processor 27 is a processing unit for converting vector data that has been generated by the CPU into image data. The clock 28 tracks the time. The image memory 29 is a unit that contains image data that has been processed by an image processor. The audio processor 30 processes audio data that has been read from an information storing section and outputs the resultant data to the speaker.

The input-output section 40 includes an input device 41 by which the user inputs data such as the destination, the transit points, and search conditions, a display 42 that displays images for visual guidance, a printer 43 that prints information, and a speaker 44 that outputs audio (voice) guidance. The input apparatus 41 is, for example, a touch panel that is disposed on the surface of the display 42, plural touch switches, a joy stick, a key switch and/or the like. A map of the vicinity of the current location, various operation screens, and travel routes to a destination are displayed on the display 42.

The information storing section 50 is connected to the information processing and controlling section 20 via a transmission channel 45. The information storing section 50 contains a map data file 51, an intersection data file 52, a node data file 53, a road data file 54, a photograph data file 55, a destination data file 56, a guidance point data file 57, a keyword data file 58, a priority order score modifying rule file 59, and other data files 60. This information storing section 50 may be a DVD-ROM or a CD-ROM, which are optical storage media, a hard drive, which is a magnetic storage medium, or any other type of information storage medium, such as a magneto-optical disk, a semiconductor memory, or the like.

Map data for national (federal) road maps, residential maps and maps for each region, are stored in the map data file 51. The road maps show roads such as main trunk roads, highways, local roads, and landmarks (facilities and the like). The residential maps include graphics that show the contours of buildings and the like, and city maps in which road names and the like are displayed. The local roads are comparatively narrow roads that have a road width that is equal to or less than a predetermined value, that is, equal to or less than a federal road or a state road, and to which traffic regulation information, such as “one way traffic”, is not appended.

Geographic coordinate data for the nodes of roads in the map, that are used in route searching, are stored in the node data file 53. Data related to roads, for example, the positions and types of roads, the number of traffic lanes, and the connections between roads, is stored in the road data file 54. Image data for photographs that have been taken of locations, such as various facilities, tourist spots and main intersections, for which a visual display is required, is stored in the photograph data file 55. Guidance data for the content of signs posted along the roads, and locations that require guidance, such as guidance for branching points, is stored in the guidance point data file 57.

Data for targets of destination searches, such as main tourist spots and buildings, locations and facilities that can be selected as destinations, such as companies and offices listed in telephone books, are stored in the destination data file 56.

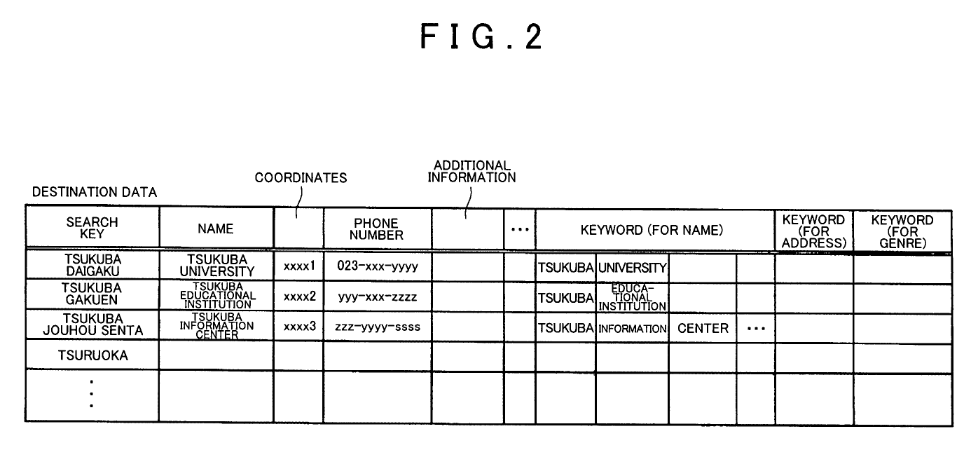

FIG. 2 schematically represents the content and structure of the destination data (location information) that is stored in the destination data file 56. As shown in FIG. 2, search keys, names, coordinates, telephone numbers, supplementary information, and the keywords, which are used in the present embodiment, are stored as destination data. The search keys are the “names” of the destinations. These search keys are represented by using Japanese katakana script, which is compatible with the input device (the 50 alphabetic keys of the touch panel in the present embodiment), but may be represented by Japanese hiragana script. The coordinates are x and y coordinate information consisting of the latitude and longitude of the destinations. The supplementary information is detailed data related to the destinations.

The keywords are stored in a manner such that the keywords for name, address, and genre can be respectively distinguished. Among the keywords, which will be described below, are keywords that correspond to destinations. For example, as name keywords, the keywords “Tsukuba” and “University” are stored for the destination “Tsukuba University”, and in the case of the destination “Mr. Donald's, Tokyo Station shop,” the keywords include “Mr. Donald's” and “Tokyo Station”. The address and genre keywords that correspond to the destinations are stored in a similar manner. Here, a genre denotes a hierarchical classification of destinations, classified into categories such as “eat-drink”, “buy-rent”, “stay”, “see-play”, “car-related facility.” At a lower level under “buy-rent”, for example, are “convenience store”, “supermarket”, “discount store”, “department store” and the like. The genres to which each of the destinations belongs are determined in advance and stored.

There are cases in which contractions and nicknames and the like are stored as keywords in the destination data, even if the words to which they refer are not themselves included in the destination data. For example, as keywords for the destination name “Arcade Kogami XX Headquarters”, in addition to “arcade”, “Kogami”, and “headquarters”, a contraction such as “arcd” may be stored as a keyword.

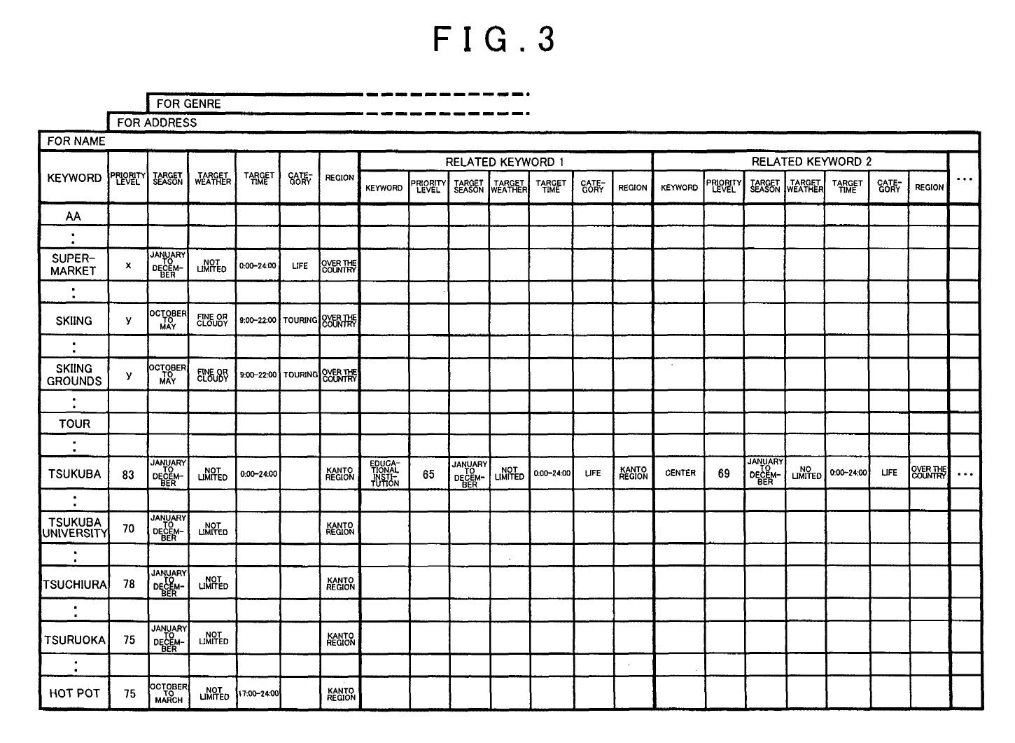

In FIG. 1, keywords that are searched for correspondence with the input characters are stored in the keyword data file 58. FIG. 3 schematically shows the content and structure of keywords that are contained in the keyword data file 58 which are similar to those contained in the destination data file 56, i.e. name keywords, address keywords, and genre keywords. Each of the keywords is a “word” (notation) that corresponds to plural sets of the destination data. “Words” that are included in a destination name and address and the like equal to or greater than a prescribed number are extracted as keywords, but in addition thereto, words that are contractions and abbreviations, such as “CS” which denotes “convenience store”, or “arcd”, which denotes “arcade”, are also generated as keywords.

In the present embodiment, the keywords that have been extracted, narrowed down as corresponding to input characters, are displayed as input keys. In addition, a priority level for display is determined for each of the extracted keywords. The priority levels are modified (adjusted) according to current conditions including season of the year, weather, time, type, and region, and conditions that correspond to each of these are set for each of the keywords. For example, because the priority level for a location candidate that includes the keyword “hot-pot cooking” is set to “75” and the corresponding season “October to March” is set for that keyword, if the date is within this period, a predetermined number of points (for example, 3 points) are added to the priority level to change the priority level from 75 to 78.

In addition, associated keywords are set for at least some keywords. Associated keywords are “words” that have a high frequency of input as search words along with the main corresponding keyword. For example, “words” that form a part of or all of the description (notation) for a destination, such as “campus” and “center” are set in association with the main keyword “Tsukuba.

In the present embodiment when a keyword is extracted (read) as corresponding to the character input and then selected by the user, a new menu listing of the associated keywords for the selected keyword is displayed as keys for the selection of a candidate (input candidate) which follows. If the total number of keywords has been narrowed down according to the character input to less than a predetermined number (for example, the largest number that can be displayed on the screen), the associated keywords that correspond to those narrowed-down keywords are displayed. As shown in FIG. 3, for associated keywords, as in the case of the main keywords, the priority level, the corresponding seasons, weather conditions, time, type, and region for modifying the priority level, are set as appropriate. Associated keywords may be provided for each set of destination data, and are treated identically to the keywords.

In the present embodiment, the main keywords and the associated keywords are searched for by input of plural keywords as an “AND” input when narrowing down the number of destination candidates. Specifically, in the case in which the keyword “A” and the associated keyword “a” are selected, destination data that has as keywords both “A” and “a” are selectively extracted (read from memory). In other words, destinations having the keyword “AND” associated keyword for names, addresses, and/or genres are read from memory to provide a menu display of a narrowed down number of destinations.

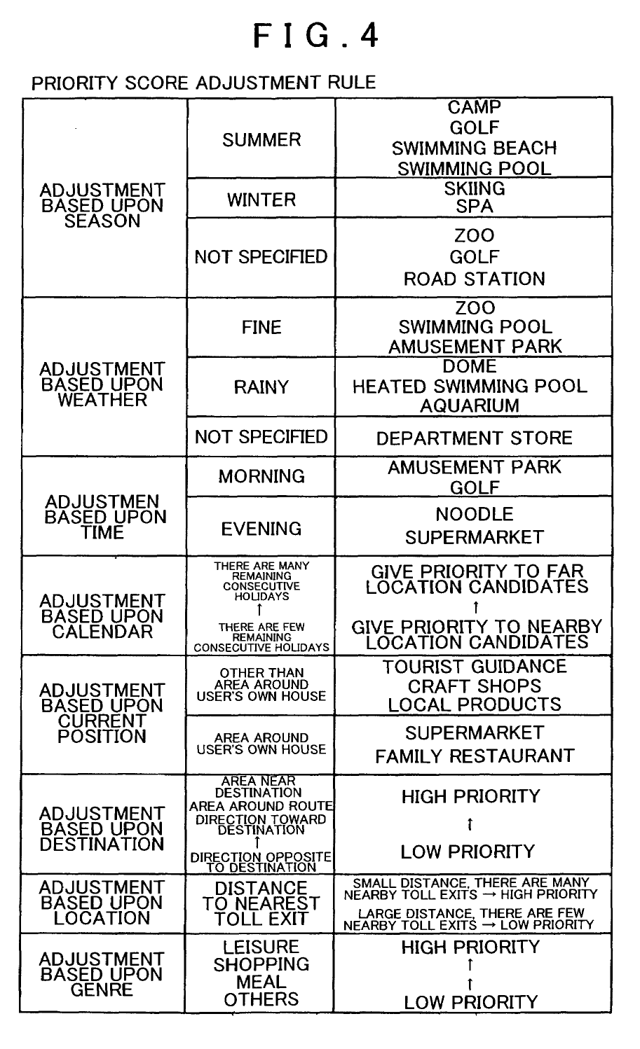

As shown in FIG. 1, the rules that modify the priority level of each keyword are set in the priority order score modifying rules file 59. FIG. 4 shows an outline of the priority order score modifying rules. Modifying rules based on a time element, a place element, a weather element, a destination element and the like and are applied during searches as priority order score modifying rules. A state in which all these modification rules apply is set as the default, and a limited number of these rules may be selected in any given search in accordance with the preferences of the user. Thereby, it is possible to display a list (menu) of the destination candidates (candidate locations) in a sequence in accordance with the preferences of a particular user. Furthermore, by allowing the user to select keywords for which the priority order (score) is to be increased or decreased, it is possible to create an ordering that accords more closely with the preferences of the user.

As shown in FIG. 4, if the season at the time of the search is summer, the priority order scores of candidate locations (destinations) that include keywords that are associated with summer, e.g. camps, golf, swimming beaches, and pools, are increased. Similarly, if the season is winter, the candidate locations that include keywords that are associated with winter, such as skiing and hot springs, are increased. In the case in which the season is not indicated, candidate locations that include keywords that are associated with, for example, zoos, golf and roadside stops along the traveled route are increased. Note that no modification rule is applied in the case in which the user has elected to disable the mode that modifies the priority scores.

If the weather is clear, the priority order scores for candidate locations that include keywords that are associated with, for example, zoos, pools, and amusement parks are increased. If the weather is rainy, priority of the candidate locations that include keywords that are associated with, for example, domed facilities, heated pools, and aquariums are increased. In the case that there is no indication of weather, the priority of candidate locations that include keywords that are associated with, for example, department stores are increased. It is possible to determine the weather based on the output of various sensors. For example, the weather can be determined based on an illuminometer, sensors that detect rain, the drive signal for the windshield wipers, the time of day and the like.

In the case in which it has been determined to be morning based on the current time, the priority order scores of locations that include keywords related to, for example, amusements parks and golf are increased, and in the case in which it is determined to be evening, the priority order scores of locations that include keywords related to, for example, restaurants and supermarkets are increased.

In addition, if, according to a calendar, today is the day before a holiday period or a day during a holiday period, locations that are distant from the current location have their priority scores increased according to the number of days remaining in the holiday period. Conversely, locations in the vicinity of the current location have their priority scores increased with passage of time (days) within the holiday period. For example, in the case in which the current location is Nagoya, if a first day of a holiday period, the priority scores of candidate locations that include keywords related to distant locations are increased, but if the holiday period is near ending or if today is a weekday, the priority scores (levels) of candidate locations that include keywords related to stores and shops and the like, which are locations in the vicinity of the current location, are increased.

In addition, in the case that the current location is the vicinity of the registered residence of the driver, e.g. within 100 km of the driver's home, the priority scores of candidate locations that include keywords related to supermarkets and family restaurants are increased. In contrast, in the case in which the current location is outside the immediate vicinity of the driver's residence, the priority scores of candidate locations that include keywords related to, for example, tourist guidance, craft shops, and local products, are increased.

In addition, responsive to selection (setting) of a destination, the priority scores of the candidate locations that are in the vicinity of the destination, in the vicinity of the travel route to the set destination, or in the direction of the destination are increased. In contrast, the priority scores of candidate locations that are located in a direction that is away from the destination are lowered, e.g. to a negative score.

In addition, the priority scores of the candidate locations are increased for candidate locations which are closer to the nearest toll exit, or according to the number of nearby toll exits. Conversely, the priority scores of the candidate locations are decreased as their distance from the nearest toll exit is longer, or with a lesser number of nearby toll exits. In addition, in the case in which a genre has been selected, the priority score is increased in the sequence of, for example, food, shopping, and leisure, and the priority scores of the other genres are decreased.

As an example of another modifying rule, the priority score is increased according to the degree that the number of input characters and the number of characters remaining after the selected keywords (the number of remaining characters) is reduced. For example, in the case in which the keywords “Sagami” and “children” are selected, the priority order is increased according to the degree that the number of remaining characters, excluding “Sagami children”, is low. As a result, the destination candidates are displayed in the priority order of: “Sagami Children's Sea”, “Sagami Children's Land”, and “Sagami Children's Land Train Station”.

In applying the priority order score modifying rules described above, in the case in which the score is to be increased, a predetermined score increment m (for example, m=5) is added, and in the case that the score to be decreased, a predetermined score increment m is subtracted. The scores before the addition or subtraction of the increment m, are the priority scores of keywords that are contained in the destination data as stored for the candidate locations. In the case that there is a plurality of keywords, the highest score after the priority score (level) has been changed is used. The priority score for candidate locations for which no keywords have been set might be, for example, 50.

The modifying rules in FIG. 4 are examples, and priority scores are modified by applying one or more of these rules. The applicable priority rules may be determined in advance, or may be selected by the user. Each of the rules is selected for application independently from the other rules.

To provide route guidance, the navigation apparatus detects the current location using the current location detecting section 10, the map information for the vicinity of the current location is read from the map data file 51 of the information storing section 50 and a map is displayed on the display 42. Then, when the destination has been set by the destination setting process, which will be described below, the information processing and controlling section 20 carries out a search for a plurality of candidates for travel routes from the current position to the destination, and displays the results on the map on the display 42. When the driver has selected one of the travel routes, the selected travel route is stored in the RAM 24 (the travel route acquiring unit), thereby setting the travel route.

Note that the information processing and controlling section 20 may transmit the current location of the vehicle (or the input departure point) and the destination to an information processing center, and the travel route may be determined in and retrieved from the information processing center. In this case, the travel route to the destination is communicated by wireless communication via the communication interface 25.

During vehicle travel, route guidance is provided by tracking the current location as detected by the current location detecting section 10. The route guidance specifies the vehicle location on the map by map matching of the road data for the set travel route and the current location as detected by the current location detecting section 10, displays a map screen of the vicinity of the current location of the vehicle on the display 42, and displays the set travel route and the current location on that map screen. The relationship between the set travel route and the current location determines the need for guidance. When travel continues straight for a predetermined distance or greater, it is determined whether or not guidance for the travel route at predetermined course change points, and directional guidance are necessary. In the case in which travel guidance is necessary, visual guidance on the display 42 and/or audio (voice) guidance is provided.

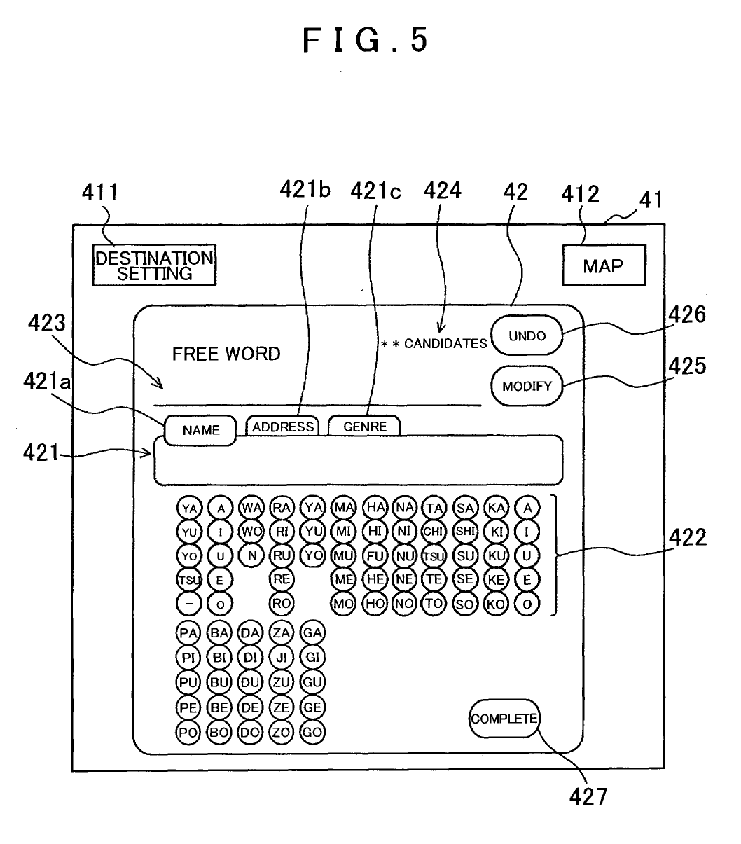

Next, the destination setting process of the present embodiment will be explained with reference to FIG. 5 which shows the input device 41 and the display 42. As shown in FIG. 5, various menu screens such as the screen for setting the destination and the map screen of the vicinity of the current location are displayed on the display 42, and a touch panel that enables selection by direct contact with a finger is provided on the display screen (display). On the outer edge of the display 42 is a fixed box for the input device 41, and a destination setting key 411, in the form of a mechanical push button (hard key), and a map key 412, for displaying the map screen of the vicinity of the current location, are provided in the upper area of this fixed box.

The destination setting key 411 is a key for displaying the destination setting screen in which the destination, transit points and the like (below, collectively referred to as the “destination”) are set. When this destination setting key 411 is operated, the destination setting according to the present embodiment is then executed. In addition to being used for route searching, the destination that is set according to the present embodiment may be used in the case in which a determined destination and a candidate destination in the vicinity of the current location are displayed on a map screen.

The display 42 in FIG. 5 provides a destination setting screen showing a keyword area 421, an input keyboard 422, an input character area 423, a candidate number area 424, a correction key 425, a return key 426, and an end key 427. The keywords (including associated keywords), that have been narrowed down according to the input of characters, are displayed in the keyword area 421. The keywords that are displayed in the keyword area 421 are displayed as input keys, and it is possible to select one or more keywords by touching the displayed keywords. Note that the keywords and the associated keywords are displayed in a manner that they can be distinguished. The keyword area 421 includes columns for names, addresses, and genres, and by selecting the name tab 421a, the address tab 421b, and/or the genre tab 421c, the keyword columns that correspond to the selected tabs and the narrowed down keywords are displayed at the top.

The input keyboard 422 include keys for inputting 50 characters. Note that a numerical keypad and/or function keys may also be displayed. The input character area 423 displays input characters that have been input by operation of the input keyboard 422, and the keywords that have been selected from the keyword area. The input characters and the keywords are displayed in a manner in which they can be distinguished. The number (count) of the candidate locations (destination data sets) that have been narrowed down in accordance with the input characters and the selected keywords is displayed in the candidate number area 424. The correction key 425 is a key for correcting an input character or a selected keyword. The return key 426 is a key for returning to the state prior to the last operation. The end key 427 is a key for displaying a list of the candidate locations for destinations that has been narrowed down by the input of the characters and the selection of keywords. Note that, as shown in FIG. 5, in the destination setting screen, a “free word” is displayed on the upper left, which display indicates input may be the first letter of a description (notation) for a destination and/or keywords and associated keywords, i.e. such input may be freely made.

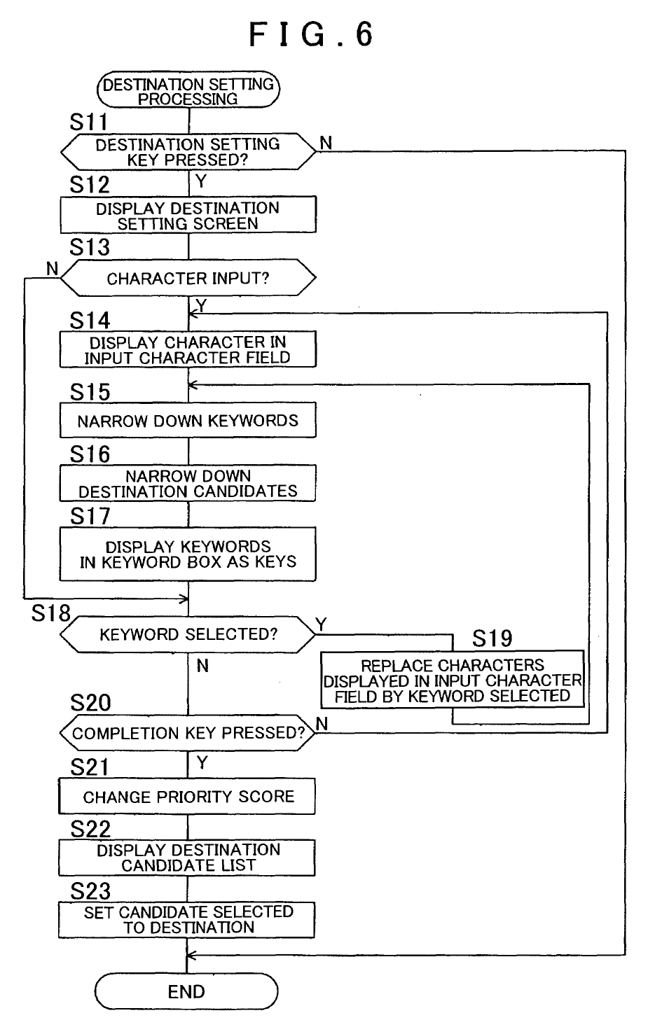

FIG. 6 is a flowchart of the destination setting process (method) of one embodiment of the present invention. Note that in the flowchart shown in FIG. 6 does not include steps of operation of the correction key 425 and the return key 426 in the setting of the destination. Both the correction key 425 and return key 426 can be operated (depressed) at any point in time before operation of the end key 427. When the correction key is 425 is operated, correction is executed, and when the return key 426 is operated, the processing returns to the previous operation. These steps may be separate routines.

The information processing and controlling section 20 monitors whether or not the destination setting key 411 has been operated (selected) by the user (step 11). When operation of the destination setting key 411 has been detected (step 11; Y), the information processing and control apparatus 20 displays the destination setting screen that is shown in FIG. 5 (step 12), and monitors whether or not characters have been input from the input keyboard 422 (step 13). In the case in which characters have been input (step 13; Y), the information processing and controlling section 20 displays the input characters in the input character display area 423 (step 14). Keywords in the keyword data file 58 that partially match the input characters (character string) displayed in the input character area 423 are retrieved (step 15). This matching of input characters with keywords is conducted for name, address, and genre keywords, and the matching keywords are stored in a specified area of the RAM 24.

Next, the information processing and controlling section 20 further narrows down the destination candidates (candidate locations) by using the input characters, which are shown in the input character area, and the narrowed-down keywords, and stores the results in the RAM 24. The number (count) of narrowed-down destination candidates is displayed in the candidate area 424 (step 16). In the narrowing down of the destination candidates by using the input characters, the search keys (refer to FIG. 2) for the destinations having destination data that partially match the input characters (one or more characters) are displayed in the input character area. In contrast, in the narrowing down by using keywords, the destination candidates are further narrowed down to those having the destination data including one of the keywords obtained in step 15. The relationship between the input characters and the keywords is an “AND” (plural term or phrase) input, and the destinations reduced (narrowed down) to those having destination data matching the input characters are stored in the RAM 24 as destination candidates.

Note that in narrowing down of the destination candidates, the destination data file 56 is used as the target when the first single character is input, and thereafter, narrowing down is carried out by using the destination candidates that are stored in the RAM 24 as targets. In the process of narrowing down the candidates in RAM 24, destination candidates other than those selected by matching are deleted. Note that for the remaining (selected) destination candidates, not all the destination data is necessarily contained in the RAM 24 which may contain only the IDs for the destination candidates. In this latter embodiment, further narrowing down is by searching the destination data, which corresponds to the IDs in the RAM 24, in the destination data file 56.

Next, the information processing and controlling section 20 displays the remaining (narrowed down) keywords in the keyword area 421 as selectable keywords (step 17). Keywords that correspond to the tabs 421a to 421c, which are displayed at the top, are displayed as columns in this keyword area 421. In addition, in the keyword area 421, although only keywords that partially match the input characters or the selected keywords are displayed, in the case in which the number of remaining keywords is equal to or less than a predetermined number, the associated keywords for these remaining main keywords are also displayed.

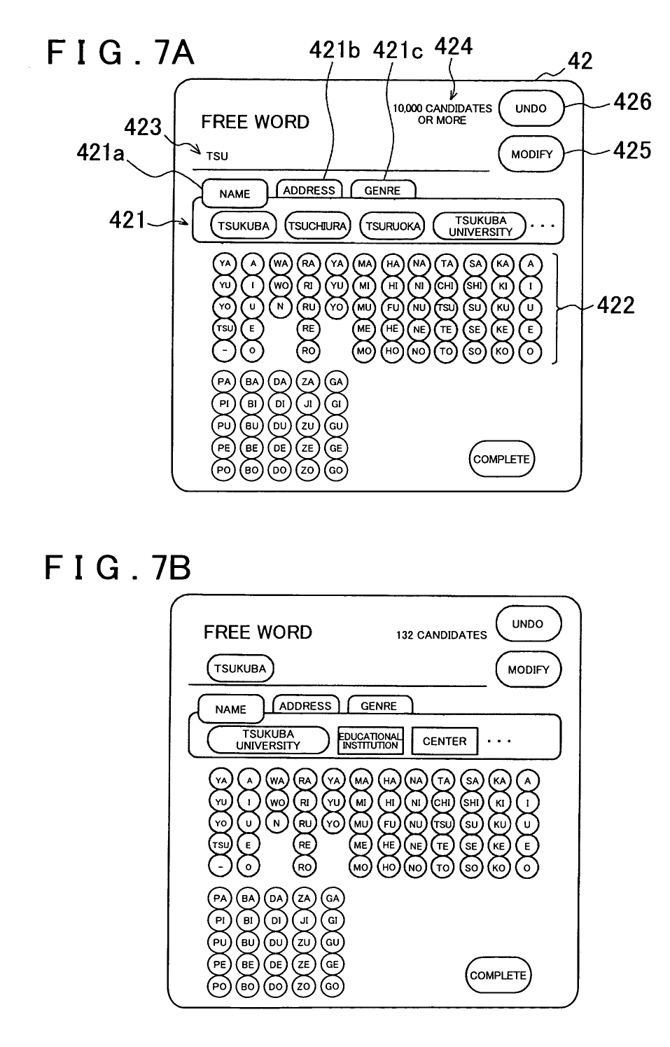

FIGS. 7A and 7B illustrate the destination setting screen for the steps that follow step 17. FIG. 7A is the destination setting screen shown after the characters “tsu” have been input from the input keyboard 422. The input characters “tsu” are displayed in the input character area 423 (step 14), and the keywords (name) “Tsukuba”, “Tsuchiura”, “Tsuruoka”, “Tsukuba University”, which correspond to and partially match the input characters “tsu”, are identified (selected) (step 15), and displayed in a keyword column under the name tab 421a (step 17).

In this destination setting screen shown in FIG. 7A, when the address tab 421b is touched, the address keywords that correspond to the input characters “tsu” are displayed in a column under tab 421b.

In step 17, the information processing and controlling section 20 changes the priority level of each keyword, based on current conditions (the corresponding season, weather, time, type, region and the like), for display of the keywords in the keyword area 421 in a sequence starting with that keyword having the highest priority score (level) after the change. In FIG. 7A, although the keyword “Tsukuba University” would be displayed before “Tsuchiura” and “Tsuruoka” if in Japanese alphabetic order, “Tsuchiura” and “Tsuruoka”, which have high priority levels (refer to FIG. 3), are displayed first. In this manner, by changing the display order of the keywords based on their priority scores, it is possible to display keywords in accord with the preferences of the user. In particular, in the case in which the current circumstances are summer, morning, and clear weather, by increasing the priority scores (levels) of the keywords related to, for example, pool and beach, it is possible to prioritize and display keywords in better accord with the preferences of the user.

Returning to FIG. 6, next the information processing and controlling section 20 monitors the next input (selection) (steps 18, 20). When a keyword in the keyword display area 421 has been selected (in step 18), the information processing and controlling section 20 changes the input characters that are displayed in the input character area (column) 423 to the selected keyword (step 19). In this case, if another keyword has already been displayed in the input character area 423 in a prior step, the newly selected keyword is displayed below this prior keyword. Note that, as shown in FIG. 7B, this keyword is displayed in a box in order to distinguish it from the input character.

After the keyword has been displayed in the input character area 423, the information processing and controlling section 20 returns to step 15, and continues narrowing down the selected keywords (step 15) and destination candidates (step 16). In step 15 following step 19, keywords that include the keywords that have been selected from among the previously narrowed-down group that is stored in the RAM 24 (step 15 after step 14) are further narrowed and keywords not selected are deleted from RAM 24. For example, in FIG. 7A, in the case in which the keyword “Tsukuba” has been selected, candidates are narrowed down to “Tsukuba University”, and the keywords “Tsuchiura” and “Tsuruoka” are deleted.

Next, the information processing and controlling section 20 displays the keywords that remain after step 15 in the keyword display area 421 (step 16). FIG. 7B shows the destination setting screen in step 16. Specifically, the destination setting screen in FIG. 7A shows the destination setting screen after the keyword “Tsukuba” has been selected. In the input character area 423, the selected keyword “Tsukuba” is displayed in the box replacing the input characters “tsu”, and the further narrowed keyword “Tsukuba University” is displayed in the keyword area 421. Next, in FIG. 7B, because only one keyword includes “Tsukuba”, that is, “Tsukuba University”, the associated keywords “campus” and “center”, which are associated with the selected keyword “Tsukuba”, are displayed. Note that in the case in which the associated keywords for the selected keyword are equal to or less than a prescribed number even after being displayed, the associated keywords for the selected (narrowed) keywords are also displayed. In the case in which the associated keywords are displayed, the associated keywords are displayed along with the keywords in a sequence starting with that keyword having the highest priority level after the priority levels have been changed based on the current circumstances (the time and place and the like). Note that the main keywords and the associated keywords are displayed in elongated circular boxes and in rectangular boxes, respectively, to distinguish the two types.

Returning to FIG. 6, in the case in which characters have been input (N in step 18; N in step 20), the information processing and controlling section 20 returns to step 14 and executes the steps following the display of the input characters (step 14). In contrast, in the case in which the end key 427 has been operated (Y in step 20), the information processing and controlling section 20 changes the priority order scores for the destination candidates (destination data) that have been narrowed down in step 16 and stored in the RAM 24 according to the priority order score modifying rules that are exemplified in FIG. 4 (step 21). The priority level of the keyword that corresponds to the destination candidate (destination data) is used as the priority order score before the change, and a predetermined score (for example, 50) that has been determined in advance is used as the score of a destination candidate for which no keyword is assigned.

Next, the information processing and controlling section 20 displays the destination candidates in a list (menu) on the destination setting screen in a sequence starting with that having the highest priority after adjustment of the priority order scores (step 22), sets the destination candidate, that the user has selected from among the displayed destination candidates, as the final destination (step 23), stores the final destination in a predetermined area of the RAM 24, and then ends the routine.

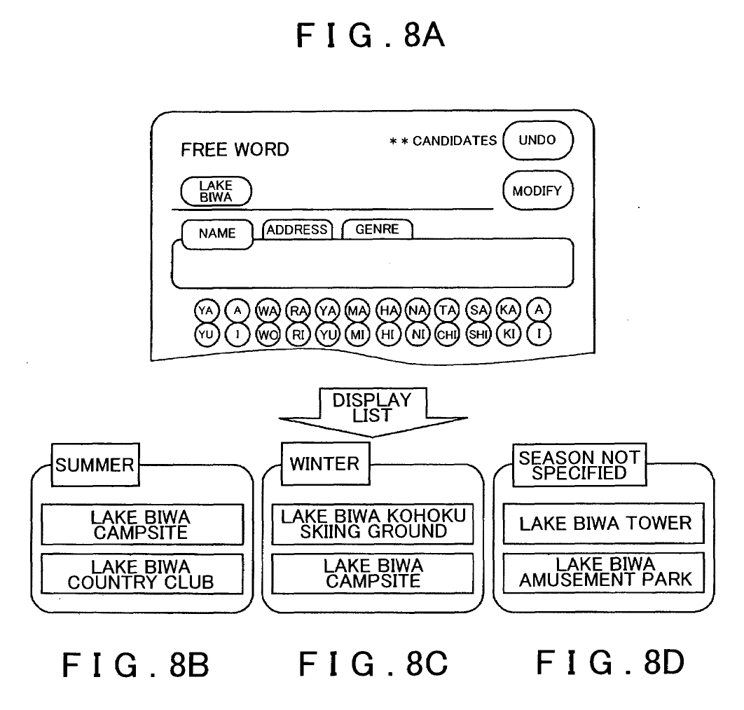

FIG. 8A to FIG. 15B illustrate the differences between the destination candidates as displayed in a list after the scores have been changed according to the priority order score modifying rules in FIG. 4. FIGS. 8A, 8B, 8C, and 8D represent the differences in the display of the list in the case in which priority levels have been adjusted by applying the season rule as the priority order score modifying rule. FIG. 8A shows display of the keyword “Lake Biwa”, which has been selected in the input character area 423. When the end key 427 is then operated, if the current season is summer, according to the season rule that increases the priority scores of the candidate locations (destinations) that include keywords related to summer, e.g. camps, golf, seaside beaches, and pools, the scores of the narrowed-down destination candidates that have been stored in the RAM 24 are changed, and as a result, as shown in FIG. 8B, a list is displayed in the sequence: “Lake Biwa Camp Sites”, “Lake Biwa Country Club”. Similarly, if the season is winter, as shown in 8C, a list is displayed in the sequence: “Lake Biwa North Skiing Grounds”, “Lake Biwa Camping Grounds”. If the season is not indicated, as shown in FIG. 8D, a list is displayed in the sequence: “Lake Biwa Tower”, “Lake Biwa Amusement Park”.

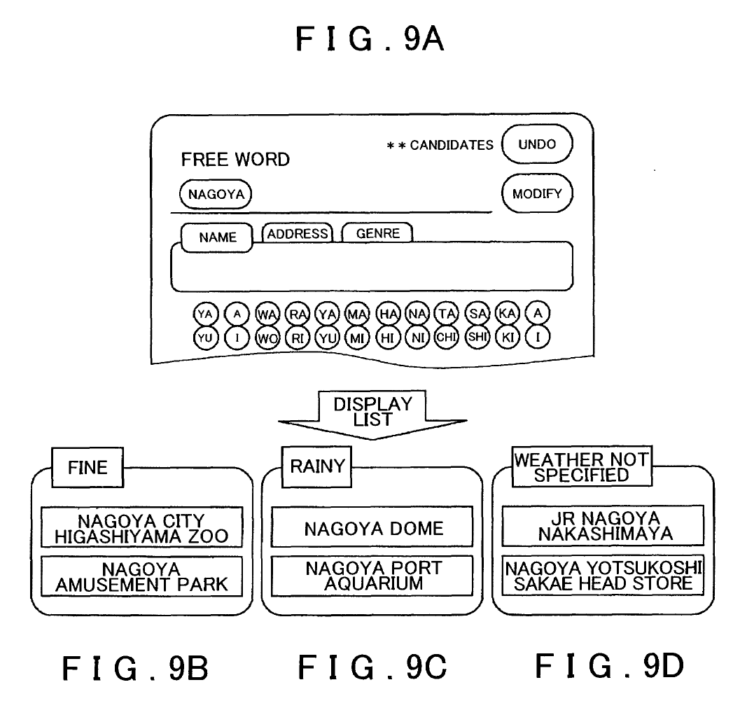

FIGS. 9A, 9B, 9C and 9D show the display of the lists in the case in which a weather modifying rule for changing the priority scores according to the weather is applied as the priority order score modifying rule. As shown in FIG. 9A, when the end key 427 has been operated with the selected keyword “Nagoya” displayed, if the weather is currently clear, as shown in FIG. 9B, a list is displayed in the sequence “Nagoya City Higashiyama Zoo”, “Nagoya Amusement Park”, according to the weather rule that increases the priority scores of the candidate locations (destinations) that include keywords associated with good weather, e.g. zoos, pools, and amusement parks. Similarly, if the weather is currently rainy, as shown in FIG. 9C, a list is displayed in the sequence “Nagoya Dome”, “Nagoya Port Aquarium”, and if the weather is not indicated, as shown in FIG. 9D, a list is displayed in the sequence of, for example: “JR Nagoya Nakashimaya”, “Nagoya Yotsukoshi Sakae Main Store”.

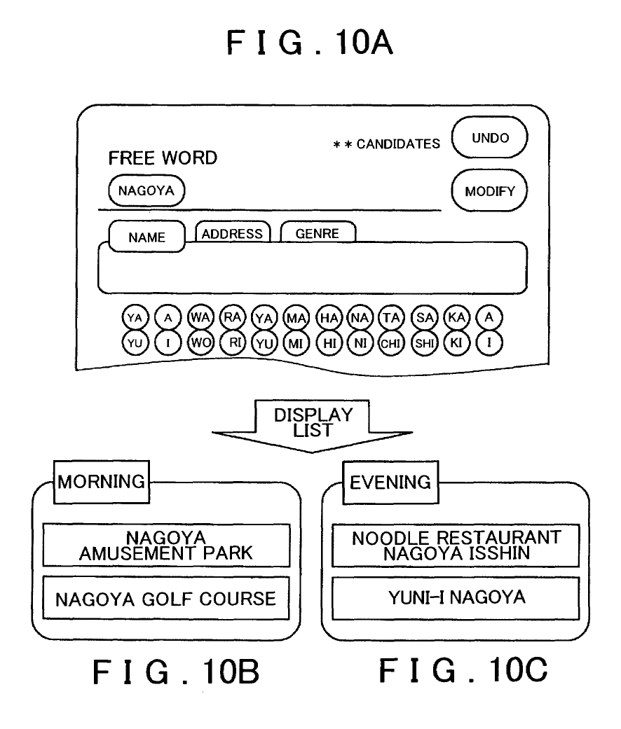

FIGS. 10A, 10B, and 10C show the display of lists in the case in which priority scores are changed according to the time rule applied as the priority order score modifying rule. As shown in 10A, when an end key 427 is operated while the selected keyword “Nagoya” is displayed, if the current time of day is in the “morning”, a list is displayed in the sequence “Nagoya Amusement Park”, “Nagoya Golf Course” and the like, according to the time (of day) rule that increases the priority scores of the candidate locations (destinations) that include keywords related to amusement parks and golf, as shown in 10B. Similarly, if the current time is in the evening, as shown in 10C, a list is displayed in the sequence “Noodles Restaurant, Nagoya Isshin”, “Uny Nagoya” and the like.

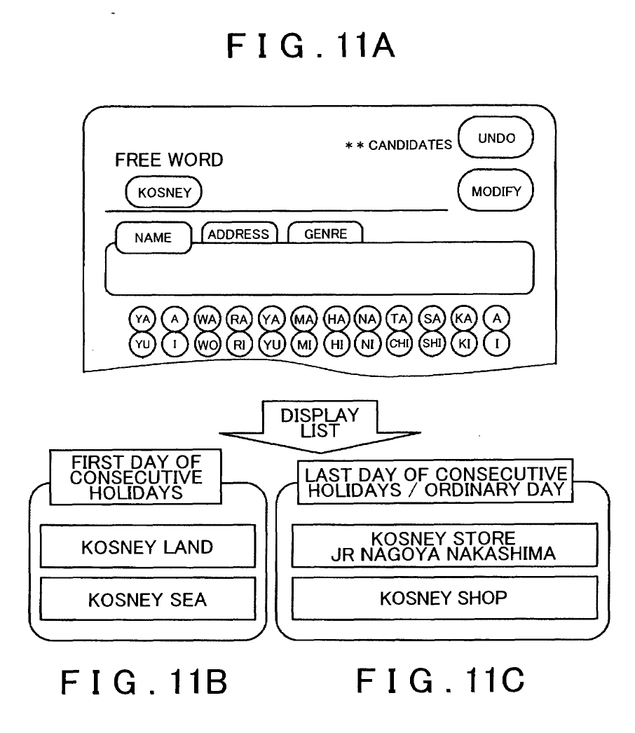

FIGS. 11A, 11B, and 11C show the display of the lists in the case in which the priority scores are changed according to the calendar (holiday) rule applied as the priority order score modifying rule. As shown in FIG. 11A, when an end key 427 is selected while the selected keyword “Kosney” is displayed, if the day is the first day of a holiday period, according to the calendar (or holiday) rule, as shown in 11B, a list is displayed in the sequence “Kosney Land”, “Kosney Sea” and the like, which are far from the current location. Similarly, in the case in which the day is the last day of a holiday period or a non-holiday weekday, as shown in 11C, a list is displayed in the sequence, “Kosney Store JR Nagoya Nakashima”, “Kosney Shop”, and the like, which are locations in the vicinity of the current location.

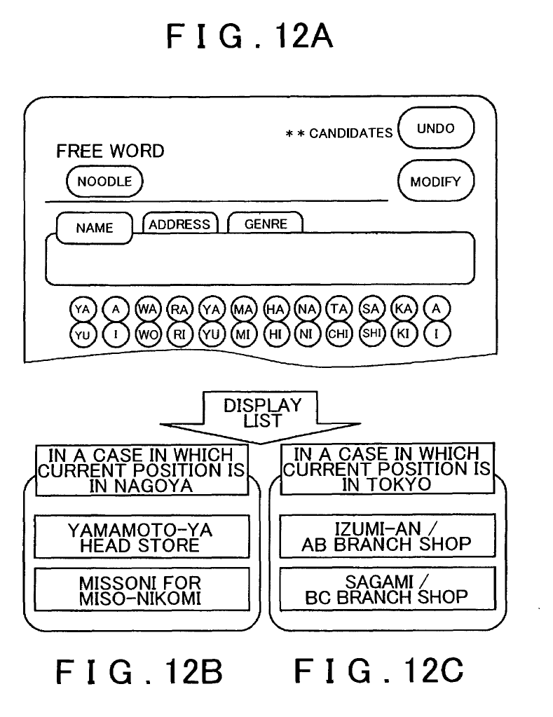

FIGS. 12A, 12B, and 12C show the display of lists in the case in which the priority scores are changed according to the current location rule applied as the priority order score modifying rule. As shown in FIG. 12A, when an end key 427 is operated while the selected keyword “noodles” is displayed, in the case in which the registered residence is in Tokyo, if the current location of the vehicle is in Nagoya, the vehicle is not in the vicinity of the residence, and thus, as shown in FIG. 12B, a list is displayed in the sequence “Yamamotoya Main Store”, “Missoni Miso Cooling” and the like, which includes keywords related to tourist guidance, craft shops, and local products. Similarly, if the current location is Tokyo, the vehicle is in the vicinity of the residence, and thus, as shown in FIG. 12C, a list is displayed in the sequence “Izumian/XY Store”, “Sagami/XY Store” and the like, which include keywords related to supermarkets and family restaurants.

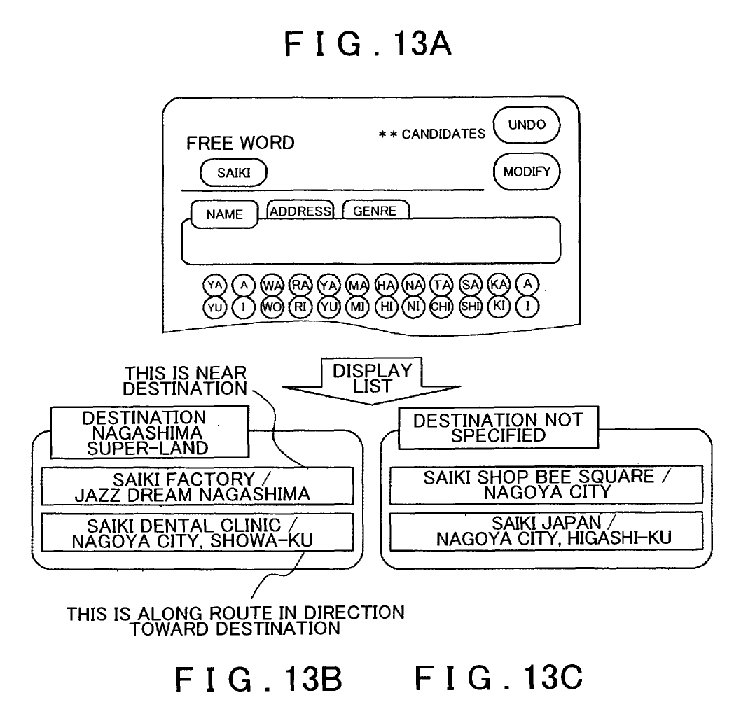

FIGS. 13A, 13B, and 13C represent displays of the lists in the case in which the destination rule is applied as the priority order score modifying rule. As shown in FIG. 13A, when an end key 427 is operated while the selected keyword “Saiki” is displayed, if Nagashima Superland has already been set as the destination, according to the priority order score modifying rule that prioritizes the vicinity of the destination, the vicinity of the route, and the direction of the destination, as shown in FIG. 13B, a list is displayed in the sequence, “Saiki Factory/Jazz Dream Nagashima”, which is closest to the destination, and “Saiki Dental Clinic/Showa Ward, Nagoya City”, and the like, which are in the same direction as the destination. In contrast, if the destination has not been set, a list is displayed in the sequence “Saiki Shop B-Square/Nagoya City”, “Saiki Japan/Higashi Ward, Nagoya City” and the like, which are in the vicinity of Nagoya, which is the current location.

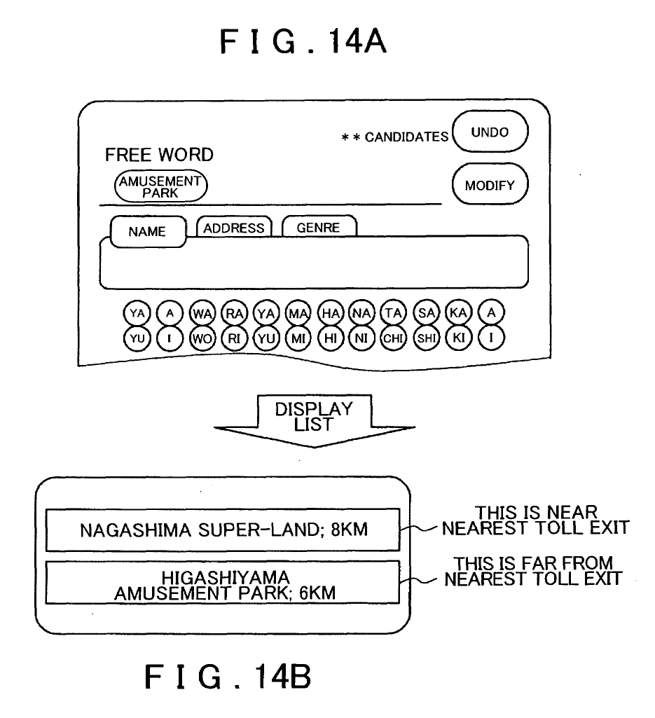

FIGS. 14A and 14B show the display of lists in the case in which the location rule is applied as the priority order score modifying rule. As shown in FIG. 14A, in the case in which the selected keyword is “amusement park”, the residence is in Naka Ward, Nagoya City, and the current location is in Nagoya, as shown in FIG. 14B, “Nagashima Superland; 8 km”, which is closet to the toll exit nearest the location of the destination candidate, and “Higashiyama Amusement Part; 6 km”, which is far from the nearest toll exit, are displayed in that sequence. Note that the 8 km and the 6 km in the display of the list, are distances from the current location. Nagashima Superland, which, even though more distant from the current location, is shorter in distance from the toll exit, and therefore has a higher priority in the display.

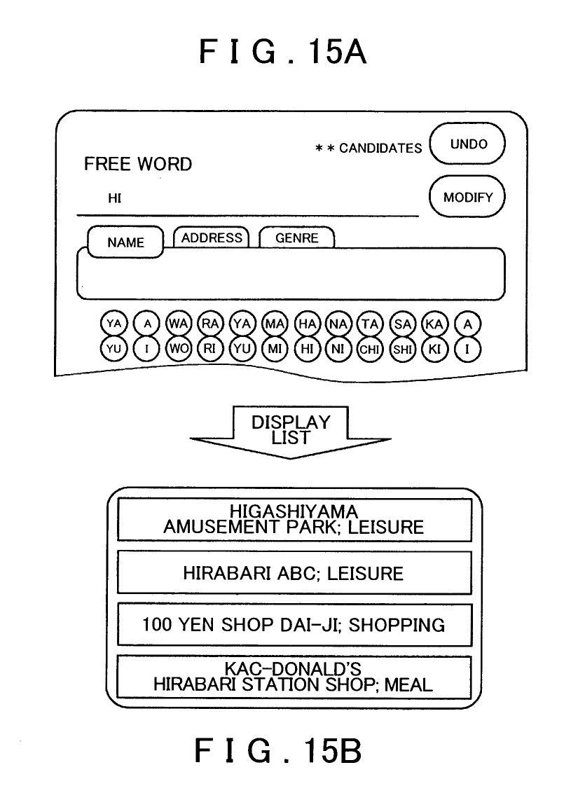

FIGS. 15A and 15B show the display of the lists in the case in which the genre rule is applied as the priority order score modifying rule. In FIG. 15A, when an end key 427 is operated after the input characters “hi” have been input, in the case in which the registered residence is Naka Ward, Nagoya City, a list is displayed in the sequence: “Higashiyama Amusement Park; leisure”, “Hirabari XYZ; leisure”, “100 Yen Shop Daisy; shopping”, “Mr. Donald Hirabari Station Shop; food” and the like, according to the genre rule that increases the priority scores in the sequence of food, shopping, and leisure, as shown in FIG. 15B.

In the above-described manner, by modifying the order of items in the list by applying priority order score modifying rules, it is possible to display a list of destination candidates in an order that is in better accord with the preferences of the user. In addition, it is possible to display lists that are in accord with the preferences of the user by modifying the priority order score modifying rules that are applied as described above and the keywords for the items to which the priority order score modifying rules are applied.

In the embodiment that has been described above, an explanation was provided for the case in which the current circumstances of season, weather, time, type, and region that modify the priority levels of the keywords are contained in the keyword data file 58, and the rules for determining the listing display order of the destination candidates are stored in the priority order score modifying rules file 59, but these may be contained in a shared file. The rules may be stored in either the keyword data files or stored separately as modifying rules. Alternatively, they may be incorporated into the program.

In addition, the foregoing embodiment has been described as having the stored keywords included in the destination data, but an ID (identification number) may be appended to each of the keywords in the keyword data file, and only the stored IDs included in the destination data. In addition, in the embodiment described above, the keywords are stored for the name, address, and genre, and the narrowing down and display of keywords is executed for each name, address, and genre; however, it is possible to use any one or two of the name, address, and genre.

### Second Embodiment

In the first embodiment described above, a navigation apparatus was explained assuming that the country of use is Japan. Specifically, in the first embodiment, the navigation apparatus was described as having Japanese specifications in which an input keyboard 422, provided with 50 alphabetic keys, serves as an input unit for the Japanese language, and data for destination searches within Japan is stored in the destination data file 56. However, the environment in which the navigation apparatus is used is not limited to Japan. For another country, it is possible to use different keyword data of an input apparatus 41 with specifications for that country.

Thus, in the second embodiment, as one example of a navigation apparatus adapted for a country other than Japan, the navigation apparatus has specifications for the United States (below referred to as “US specifications”). The structure of the navigation apparatus and the destination setting process that are used in the second embodiment are fundamentally identical to those of the first embodiment. In the explanation of the second embodiment, structures that are identical to those of the first embodiment have identical reference numerals appended and the explanations thereof are omitted, i.e. only differences are explained.

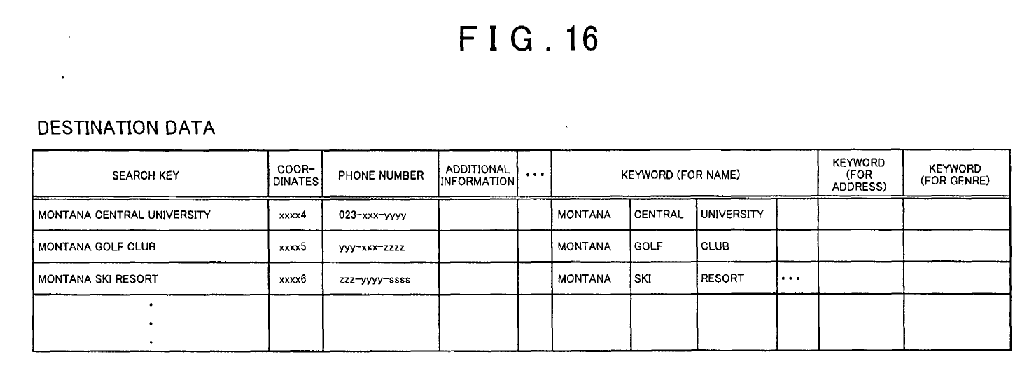

FIG. 16 schematically shows the content and structure of the destination data (location information) that is stored in the destination data file 56. As shown in FIG. 16, in the navigation apparatus with US specifications, the name within the destination data is directly registered as a search key. In addition, the search keys for the US are different from those designed for use in Japan and are separated by a space between each word. The search key is the “name” of the destination, and this search key is compatible with the input apparatus (in the second embodiment, the alphabet keys of the touch panel), and both upper case letters and lower case letters are used together. However, searches are executed without distinguishing between upper case letters and lower case letters, i.e. the searches are not “case sensitive”. In the second embodiment, the names for the destination data in the United States are stored in the destination data file 56.

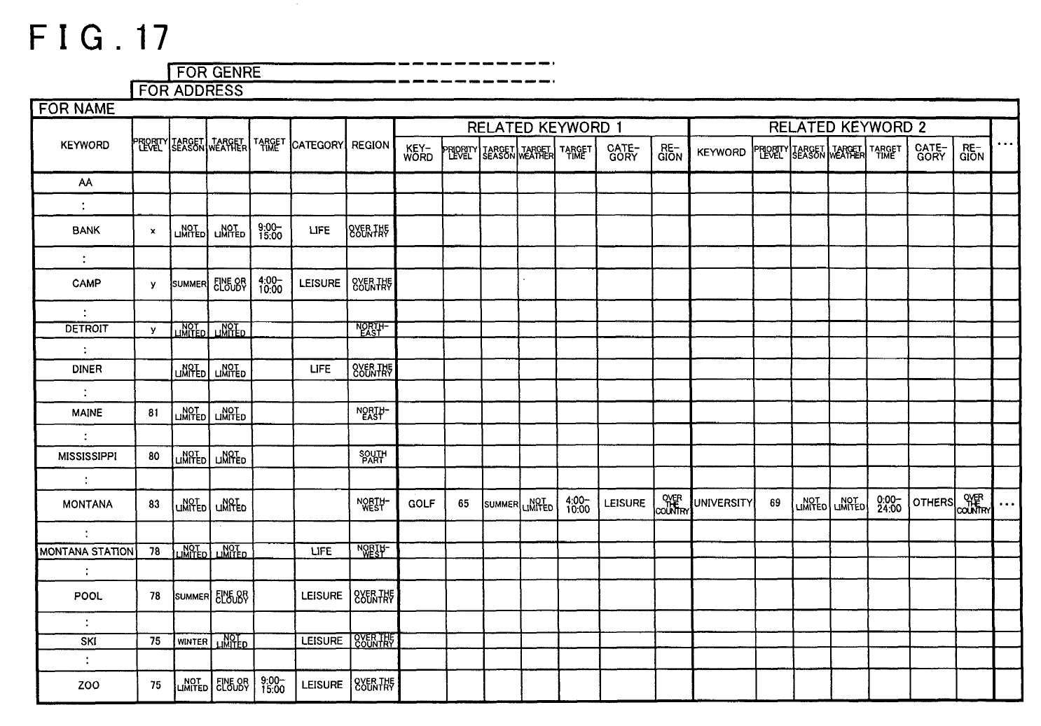

FIG. 17 schematically shows the keywords that are contained in the keyword data file 58, each of which keywords consists of words that form the name for each destination datum. As shown in FIG. 17, in the navigation apparatus having US specifications as well, similar to the first embodiment, a priority level is determined for each of the keywords that are in the alphabet character string. For example, the priority level of the location candidates that include the keyword “Montana” is set to “83”, and the region is set to “northwest”. Thus, if the current location is within the northwest, a predetermined increment of n points (for example, 3 points) are added to 83, and the priority level is thereby changed to 86. In addition, associated keywords are set in association with the main keywords. For these keywords, words that have a high probability of being input as search words along with the main keyword, for example, words that form a part of all of the description of a destination along with the keyword, such as “golf” or “university” for the keyword “Montana” are set as associate keywords.

Note that the season of the year in the keyword data file 58 is set so as to correspond to the country or region where the navigation apparatus is to be used. For example, in the case in which the country of use is Japan, the period from December to February is set as winter, and in the case in which the country of use is Australia, which is located in the southern hemisphere, the period from June to August is set as winter. In addition, the corresponding times that are set in the keyword data file 58 are set so as to correspond to the country or region in which the navigation apparatus is to be used. For example, in a country or region that has introduced daylight saving time, the corresponding time is advanced by one hour during the summer.

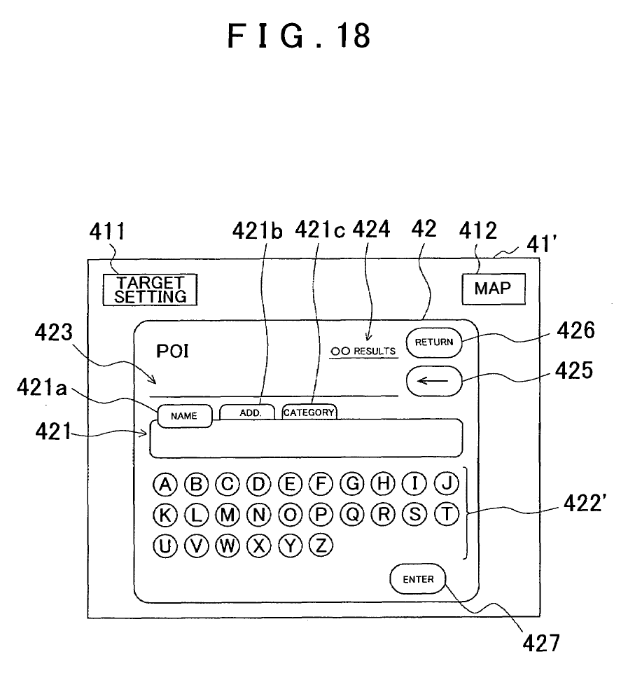

FIG. 18 shows the input apparatus 41′ and the display 42 in the navigation apparatus that has US specifications. In FIG. 18, in order to explain the navigation apparatus that has US specifications, English characters are used, but identical reference numerals are appended to the keys and display areas having functions that are identical to those in the first embodiment (FIG. 5). As shown in FIG. 18, the input keyboard 422′ has keys for inputting the alphabetic characters A to Z.

With the navigation apparatus in which the specifications of the input apparatus 41 and each of the sets of data are in accordance with US specifications, destination setting is identical to that in the first embodiment (FIG. 6) described above. However, in the second embodiment, alphabetic characters (character strings) are input by using the input keyboard 422′, and a destination data file 56 and a keyword data file 58 that have the US specifications described above are referenced in searching for destination candidates.

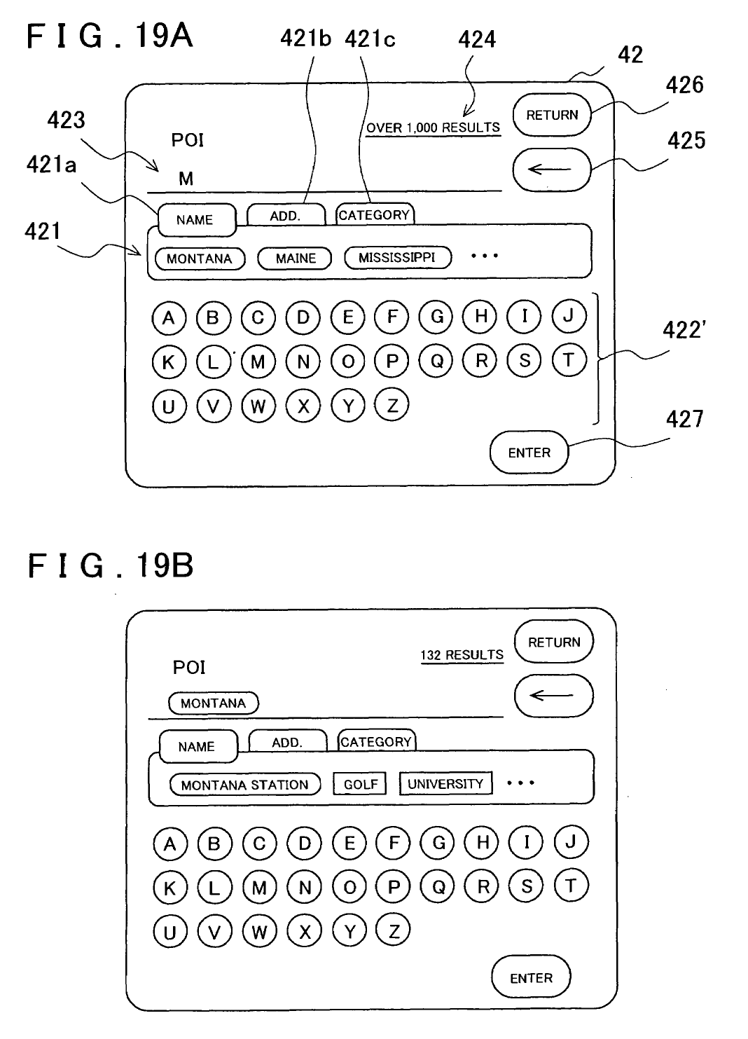

FIGS. 19A and 19B show an example of the display state of the destination setting screen used in the processing following step 17 with the navigation apparatus having US specifications. FIG. 19A is the destination setting screen generated responsive to input of the alphabet character “M” from the input keyboard 422′. The input character “M” is displayed in the input character area 423, and at the same time, the keywords (names) that partially match the corresponding input character “M” are narrowed down to “Montana”, “Maine”, “Mississippi”, and the like, which are displayed responsive to touching of the name tab 421a. With the destination setting screen shown in FIG. 19A, when the address tab 421b is touched, the address keyword area 421 is displayed at the top, and the address keywords that have been retrieved because of correspondence to the input character “M” are displayed therein.

In the case in which the keywords are displayed in the keyword display area 421 as selectable keys, similar to the first embodiment, by applying the priority order score modifying rules (FIG. 4), the priority level of each keyword is modified based on the present circumstances (corresponding season, weather, time, type, region, and the like). Thus, the keywords are displayed in the keyword area 421 in an order descending from the keyword that has the highest priority level, after the priority levels have been modified. In FIG. 19A, in alphabetic order, the keyword “Maine” appears before “Mississippi” and “Montana”, but “Montana”, because it has a higher priority level (refer to FIG. 17), is displayed first. In this manner, using a navigation apparatus with US specifications, by modifying the display order of the keywords in accordance with their priority levels, it is possible to display a list (menu) of keywords that is suited to the users' needs.

From the state shown in FIG. 19A, responsive to selection of the keyword “Montana” from the keyword display area 421, the information processing control apparatus 20 replaces the input characters that are displayed in the input character area 423 with “Montana”. In this case, if other keywords are already displayed in the input character area 423 as a result of previous operations, the newly selected keyword is displayed after those previously displayed keywords. In addition, the information processing control apparatus 20 narrows down the listing of selected keywords and narrows down the destination candidates. For example, in the case in which the keyword “Montana” has been selected in FIG. 19A, the selection is narrowed down to “Montana”, and the other keywords “Maine” and “Mississippi” are deleted.

FIG. 19B shows the destination setting screen as it appears after the keyword “Montana” has been selected from the destination setting screen in FIG. 19A. As shown in FIG. 19B, in the input character area 423, the selected keyword “Montana” is displayed in the box, replacing the input character “M”. In addition, in the keyword area 421, the further narrowed keyword “Montana Station” and the associated keywords “golf” and “university”, which are associated with the selected keyword “Montana”, are displayed. Note that in the case in which the associated keywords are displayed, similar to the first embodiment, the associated keywords and the main keywords are displayed in a sequence descending from that having the highest priority level (after modification), based on the current circumstances (time, place, and the like). In this manner, with a navigation apparatus having US specifications, similar to the first embodiment, by repeatedly selecting the keywords that have been displayed in a list, it is possible to search for a destination.

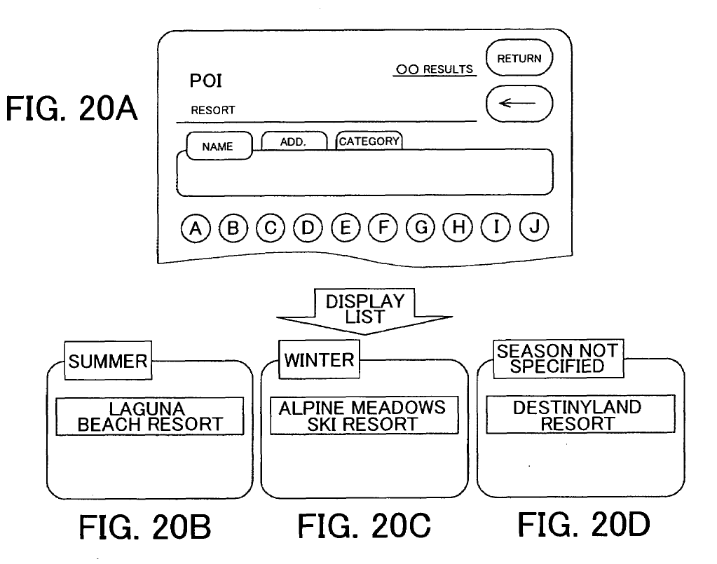

FIG. 20 to FIG. 27 show examples of destination candidates displayed in a list depending on the scores that have been altered according to the priority order score modifying rules in FIG. 4, in use of the navigation apparatus having US specifications. FIG. 20 shows the display of the lists in the case in which the season rule is applied as a priority order score modifying rule. FIG. 20A shows display “Resort”, as the selection from input character area 423. In this state, when the end key (Enter) 427 is operated, similar to the first embodiment, according to the destination rule that increases the priority order score of the candidate points (destinations) that include keywords that are associated with summer, assuming the current season is summer, the scores of the narrowed-down destinations that are contained in the RAM 24 are changed, and the result is as shown in FIG. 20B, with “Laguna Beach Resort” displayed in the list with highest priority. Similarly, if the season is winter, as shown in FIG. 20C, “Alpine Meadows Ski Resort” is given higher priority in the display. If the season is not indicated, as shown in FIG. 20D, “Destinyland Resort” is given higher priority and displayed.

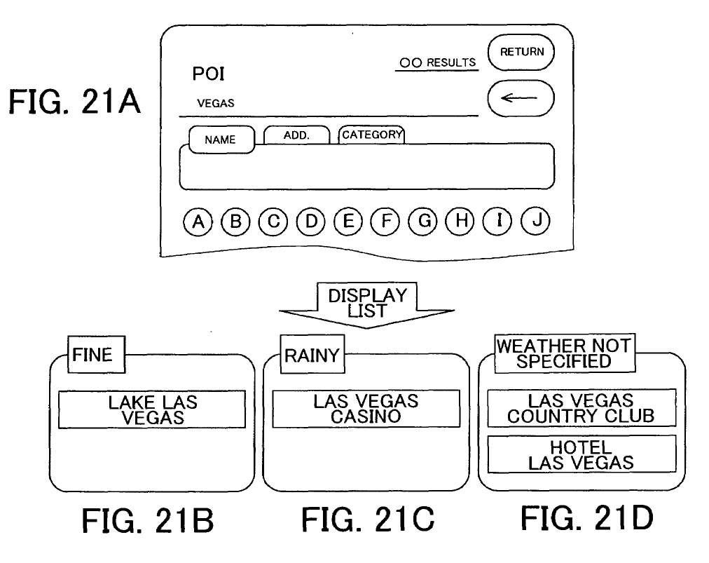

FIG. 21A to FIG. 21D show the display of the lists in the case in which a weather rule is applied as a priority order score modifying rule. As shown in FIG. 21A, when the end key (Enter) 427 is operated while the input keyword “vegas” is displayed in the input character display area 423, if the current weather is clear, based on the priority order score modifying rule, as shown in FIG. 21B, “Lake Las Vegas”, for example, is prioritized and displayed. Similarly, if the current weather is rainy, as shown in FIG. 21C, “Las Vegas Casino” is prioritized and displayed, and if the weather has not been indicated, as shown in FIG. 21D, a list is displayed in the order of, for example: “Las Vegas Country Club”, “Hotel Las Vegas”, and the like.

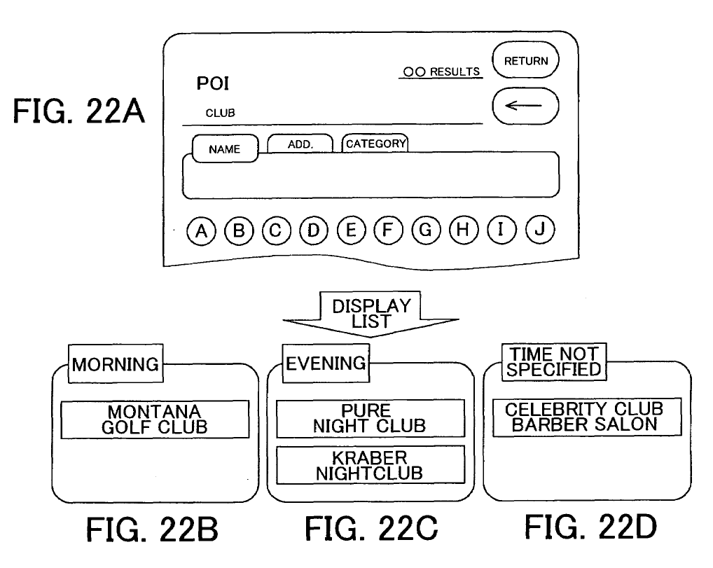

FIG. 22A to FIG. 22D illustrate display of the lists in the case in which a time rule is applied as the priority order score modifying rule. As shown in FIG. 22A, when the end key (Enter) 427 is operated while the input keyword “club” is displayed in the input character area 423, if the current time is in the morning, applying the priority order score modifying rule, as shown in FIG. 22B, “Montana Golf Club” is prioritized and displayed. Similarly, if the current time is in the evening, as shown in FIG. 22C, a list is displayed in the order of, for example, “Pure Night Club”, “Kraber Nightclub” and the like, and if the time has not been indicated, as shown in FIG. 22D, “Celebrity Club Barber Salon” is prioritized and displayed.

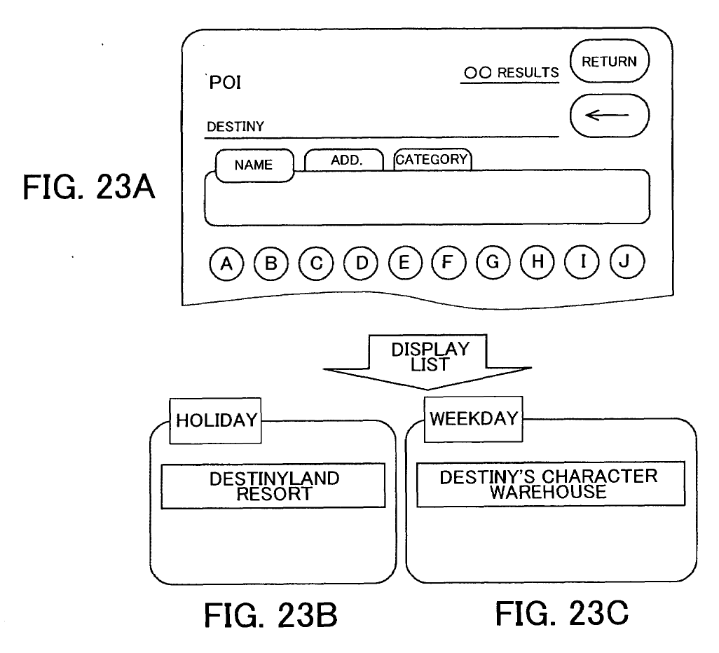

FIG. 23A to FIG. 23D illustrate display of the lists in the case in which a calendar rule is applied as a priority order score modifying rule. As shown in FIG. 23A, when the end key (Enter) 427 is operated while the input keyword “destiny” is displayed in the input character column 423, if today is a holiday, according to the priority order score modifying rule, as shown in FIG. 23B, “Destinyland Resort”, which is distant from the current location, is prioritized and displayed. Similarly, in the case in which today is a weekday, as shown in FIG. 23C, “Destiny's Character Warehouse”, which is a location nearby, is prioritized and displayed.

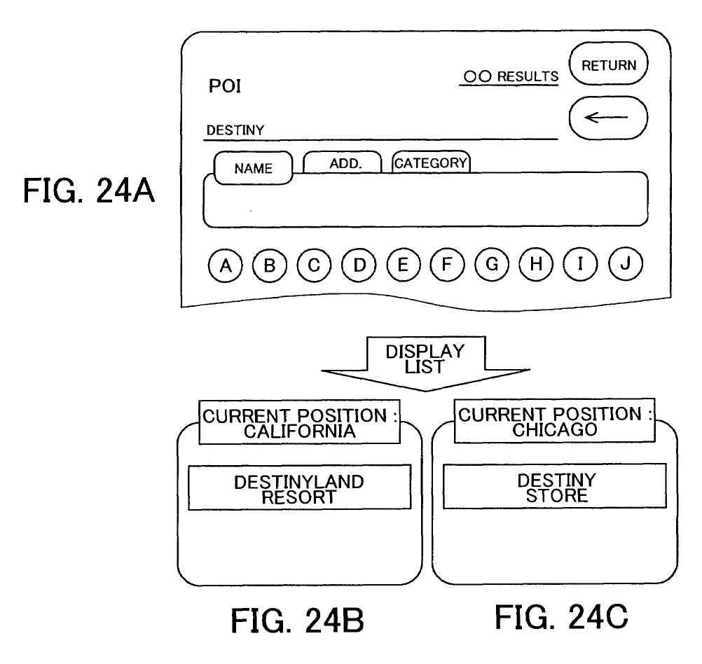

FIG. 24A to FIG. 24D show display of the lists in the case in which a current location rule is applied as a priority order score modifying rule. As shown in FIG. 24A, when the end key (Enter) 427 is operated while the input keyword “destiny” is displayed in the input character area 423, in the case in which the current location is in California, as shown in FIG. 24B, “Destinyland Resort”, which includes a keyword associated with California, is prioritized and displayed. Similarly, if the current location is in Chicago, as shown in FIG. 24C, “Destiny Store”, which includes a keyword that is associated with Chicago, is prioritized and displayed.

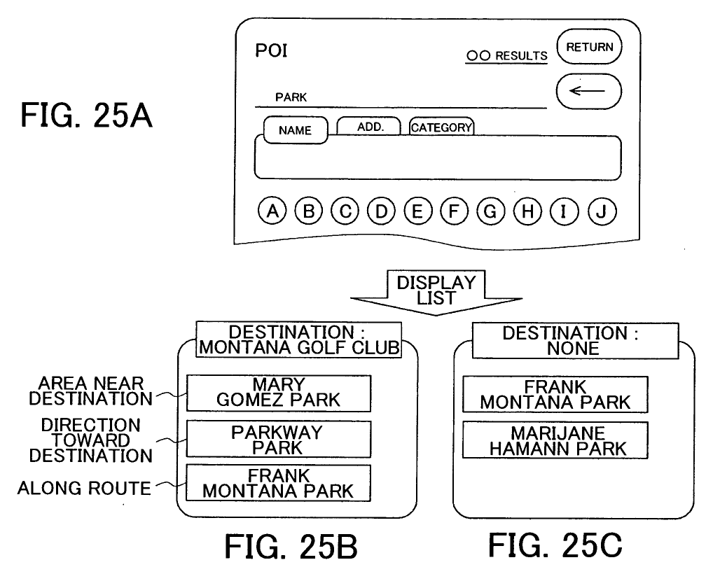

FIG. 25A and FIG. 25B show the display list in the case in which a destination rule is applied as a priority order score modifying rule. As shown in FIG. 25A, when the end key (Enter) 427 is operated while the input keyword “park” is displayed in the input character area 423, if “Montana golf club” has already been set as a destination, due to the priority order score modifying rule that prioritizes the vicinity of the destination, the direction of the destination, and the proximity to the route, as shown in FIG. 25B, a list is displayed in the order: “Mary Gomez Park”, which is nearest the destination, “Parkway Park”, which is in the same direction as the destination, and “Frank Montana Park”, which is along the route. In contrast, if the destination has not been set, a list is displayed in the order of, for example: “Frank Montana Part”, “Marijane Hamann Park” and the like, which are in the vicinity of the current location.

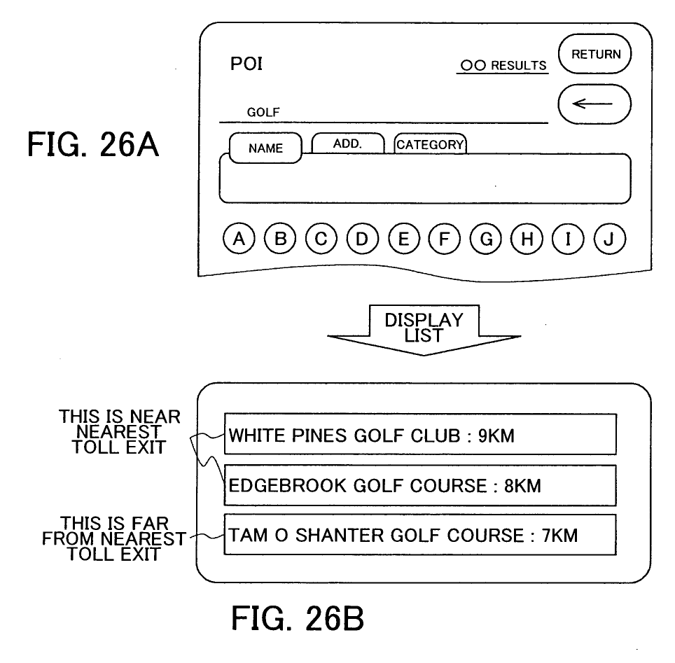

FIG. 26A and FIG. 26B illustrate display of the lists in the case in which a location rule is applied as a priority order score modifying rule. As shown in FIG. 26A, when the end key (Enter) 427 has been operated while the input keyword “golf” is displayed in the input character area 423, as shown in FIG. 26B, the displayed list is in the order of, for example: “White Pines Golf Club: 9 km” and “Edgebrook Golf Course: 8 km”, which are close to the nearest toll exit relative to the current location, followed by “Tam O Shanter Golf Course: 7 km”, which is more distant from the nearest intersection. Note that the “9 km”, “8 km”, and “7 km” that appear in the display of the lists are the distances from the current location. Even though distant from the current location, “White Pines Golf Club: 9 km”, which is a short distance from the toll exit, is given top priority in the displayed menu.

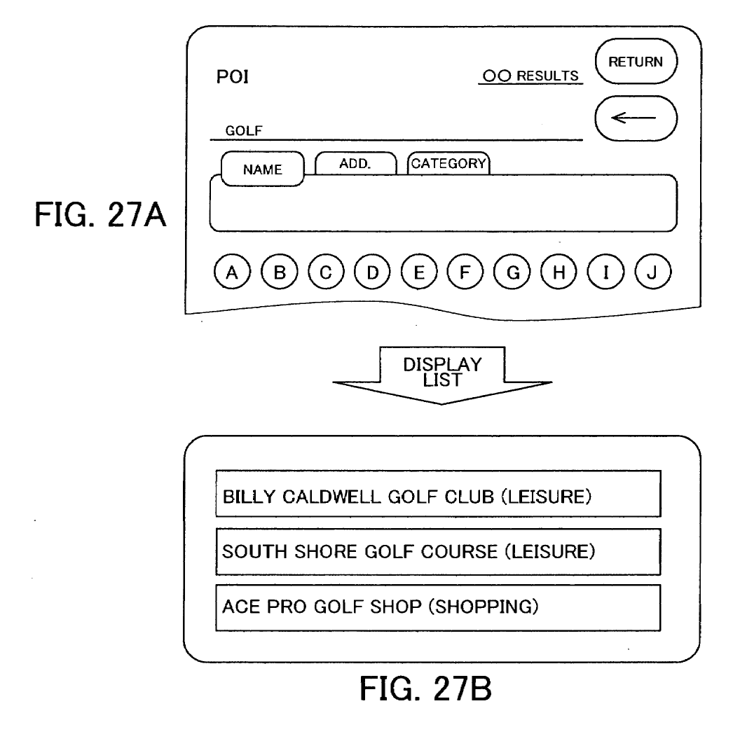

FIG. 27A and FIG. 27B show the differences in the display of the lists in which a genre rule is applied as a priority order score modifying rule. In FIG. 27A, when the end key (Enter) 427 is operated while the input keyword “golf” is displayed in the input character display area 423, based on the priority order score modifying rule, as shown in FIG. 27B, a list is displayed in the order: “Billy Caldwell Golf Club (leisure)”, “South Shore Golf Course (leisure)”, “Ace Pro Golf Shop (shopping)”, and the like.

In this manner, with a navigation system having US specifications and in which letters of the alphabet are input into the input character area 423, it is possible to display a list of destination candidates in an order that is more appropriate for the user, changing the order of the list by applying priority order score modifying rules, similar to the first embodiment.

In the second embodiment, a navigation apparatus having US specifications has been exemplified as an example of a navigation apparatus that is used outside Japan. However, the country or region in which the navigation apparatus may be used is not limited. It is possible to use the navigation apparatus in any country or region, such as Germany, Spain, France, Arab countries, China, Korea, or Australia or the like. However, the input apparatus 41 including the input keyboard 422 should be compatible with the language of the country (region) in which the navigation apparatus is to be used, and in addition, the stored data should correspond to the language of country (region) in which the navigation apparatus is to be used. For example, in the case in which the navigation apparatus is to be used in China, the input apparatus 41 is provided with an input keyboard 422 that is compatible with the Pinyin input for the Chinese language. In addition, data that represents, in the regional language, the names in the destination data that correspond to the country or region in which the navigation apparatus is to be used are stored in the destination data file 56.

The language that is to be input need not correspond to the country (region) in which the navigation apparatus is used. For example, a navigation apparatus compatible with German language input may be used in France. In this case, data that is compatible with the input language is stored in the database used in conducting a destination search, e.g. the data that is compared with the input characters (for example, the name of the destination, the keywords, and the address and the like), in the destination data file 56 and in the keyword data file 58. In addition to the input language, data that is compatible with the language of the country (region) where the navigation apparatus is to be used may be stored with the data that is to be searched. In addition, data that will not become a search object, for example, data for supplementary information retrieved in destination searches, need not be stored in a form that is compatible with the input language. For example, with data that will not be used in searching may be stored data that is compatible with an input language, data that is compatible with the language of a country (region) in which the navigation apparatus will be used, and data that is compatible with both the input language and the language of the country (region) in which the navigation apparatus is to be used.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

I claim:

1. A navigation apparatus comprising:
a keyword storage unit for storing keywords;
a destination data storing unit containing stored therein a plurality of sets of destination data including sets of destination data in correlation with one or more keywords;
a character input unit for input of search characters;
a display unit for display of retrieved keywords in a manner allowing selection by a user of one of the displayed keywords and for display of candidate destinations in a manner allowing selection of one of the candidate locations by the user; and
an information processing and controlling section for retrieving, from the keyword storage unit, keywords containing the input search characters for display by the display unit and selection of one of the displayed keywords by the user and for identifying destinations, having stored destination data including the selected keyword, as the candidate locations for display by the display unit and selection by the user.

2. A navigation unit according to claim 1 wherein the information processing and controlling section retrieves location candidates containing the input search characters from the destination data storing unit, stores the retrieved location candidates and narrows the stored location candidates to those having data matching a keyword selected by the user.

3. A navigation unit according to claim 1 wherein the information processing and controlling section identifies words contained in a plurality of destination data sets and stores those identified words as keywords in the keyword storage unit.

4. The navigation apparatus according to claim 1, wherein
main keywords and associated keywords which correspond to at least a portion of a main keyword are included in the destination data; and
retrieved main keywords and associated keywords that correspond to retrieved main keywords are displayed together for selection by the user.

5. The navigation apparatus according to claim 1, wherein
a priority level for display and modifying conditions that modify the priority level based on current circumstances are determined for each of the keywords that have been stored in the keyword storage unit; and
the information and controlling section prioritizes the keywords in order from the keywords having the highest priority level after the priority levels of the keywords stored in the keyword storage unit have been modified based on the current circumstances.

6. The navigation apparatus according to claim 5, wherein the current circumstances used to modify the priority levels are at least one of season of the year, weather, time, type, and region.

7. A computer-readable medium having encoded thereon a navigation program which makes a computer function as:
a character input unit for input of search characters;
a display unit for display of retrieved keywords in a manner allowing selection by a user of one of the displayed keywords and for display of candidate destinations in a manner allowing selection of one of the candidate locations by the user; and
an information processing and controlling section for retrieving from storage keywords containing the input search characters for display by the display unit and selection of one of the displayed keywords by the user and for identifying destinations, having stored destination data including the selected keyword, as the candidate locations for display by the display unit and selection by the user.
